(19) United States
(12) Patent Application Publication
(10) Pub. No.: US 2024/0210638 A1
(43) Pub. Date: Jun. 27, 2024

(54) OPTICAL COUPLING SYSTEM AND PREPARATION METHOD THEREFOR

(71) Applicant: InnoLight Technology (Suzhou) Ltd., Suzhou (CN)

(72) Inventors: Xue-zhe ZHENG, Suzhou (CN); Yin-chao DU, Suzhou (CN); Feng WANG, Suzhou (CN)

(21) Appl. No.: 18/598,561

(22) Filed: Mar. 7, 2024

Related U.S. Application Data
(63) Continuation of application No. PCT/CN2022/103217, filed on Jul. 1, 2022.

(30) Foreign Application Priority Data
Sep. 10, 2021 (CN) 202111059374.7

(51) Int. Cl. G02B 6/42

(52) U.S. Cl. CPC G02B 6/4257; G02B 6/4231; G02B 6/424; G02B 6/4244; G02B 6/4245

(57) ABSTRACT

An optical coupling system and a preparation method therefor are provided. The preparation method for the optical coupling system includes: providing a substrate, mounting an optical chip on the substrate, and forming a first intermediate member; fixing an optical fiber in a fixing structure, forming an optical fiber assembly; providing a connection assembly that includes a chip-side connector and an optical fiber-side connector; fixedly connecting the optical fiber-side connector to the optical fiber assembly, connecting the other end of the optical fiber-side connector to the chip-side connector, and forming a second intermediate member; adjusting the position of the second intermediate member relative to the first intermediate member; and when the optical chip and the optical fiber achieve optimal optical coupling, stopping the adjustment of the relative position, and fixing the chip-side connector to the substrate.

### CROSS-REFERENCE TO RELATED PATENT APPLICATION

This application is a continuation application of International Patent Application Ser. No. PCT/CN2022/103217, filed on Jul. 1, 2022, which claims the priority of China Patent Application No. 202111059374.7, filed on Sep. 10, 2021, in the People's Republic of China. The entirety of each of the above patent applications is hereby incorporated by reference herein and made a part of this specification.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to the field of optoelectronics technology, and more particularly to an optical coupling system and a preparation method therefor.

### BACKGROUND OF THE DISCLOSURE

With the booming development of the Internet of Things and wireless communication technology and applications, IP network data traffic continues to grow rapidly. In particular, the rapid growth of cloud computing and big data applications drives a continuously high demand for construction of large-scale data centers. The scale of the optical communication market grows rapidly due to generational changes of the digital communication market.

At the same time, with the rapid increase in power consumption, cost, and volume of conventional package solutions for discrete devices, there is accelerated development in optoelectronics for communication from discrete devices to integration. Optoelectronic interconnection technology has always been one of the important development technologies of photon integration. A key technology of optoelectronic interconnection is to achieve the efficient optical coupling of optical chips and optical fibers.

However, at present, it is difficult for optical chip and optical fiber coupling technology to achieve both fast and accurate coupling.

### SUMMARY OF THE DISCLOSURE

In response to the above-referenced technical inadequacies, it is necessary to provide an optical coupling system and a preparation method therefor.

A preparation method for an optical coupling system for coupling and connecting an optical chip to an optical fiber includes the following processes: providing a substrate, and mounting an optical chip on the substrate to form a first intermediate member; fixing an optical fiber in a fixing structure to form an optical fiber assembly; providing a connection assembly, the connection assembly including a chip-side connector and an optical fiber-side connector, and the chip-side connector and the optical fiber-side connector being used for detachable connection; fixedly connecting one end and another end of the optical fiber-side connector to the optical fiber assembly and the chip-side connector, respectively, to form a second intermediate member; adjusting a position of the second intermediate member relative to the first intermediate member; and when the optical chip and the optical fiber achieve optimal optical coupling, stopping adjustment of the relative position and fixing the chip-side connector to the substrate.

In one embodiment, after stopping adjustment of the relative position when the optical chip and the optical fiber achieve the optimal optical coupling, and fixing the chip-side connector to the substrate, the preparation method further includes: disassembling the chip-side connector from the optical fiber-side connector.

In one embodiment, the processes of providing the substrate, and mounting the optical chip on the substrate to form the first intermediate member further includes: providing a substrate; mounting the optical chip on the substrate; and mounting a first lens structure on the substrate, and the first lens structure being located on one side of the optical chip.

In one embodiment, the processes of mounting a first lens structure on the substrate further includes: adjusting a position of the first lens structure relative to the optical chip; and mounting the first lens structure on the substrate.

In one embodiment, the processes of mounting the first lens structure on the substrate includes: fixing the first lens structure on the substrate by laser welding or eutectic soldering; and stopping adjustment of the relative position when the optical chip and the optical fiber achieve optimal optical coupling, and in which the processes of fixing the chip-side connector to the substrate includes: fixing the chip-side connector on the substrate by laser welding or eutectic soldering.

In one embodiment, the processes of fixedly connecting one end and another end of the optical fiber-side connector to the optical fiber assembly and the chip-side connector, respectively, to form the second intermediate member includes: mounting a second lens structure on one end of the optical fiber-side connector; connecting one end of the optical fiber-side connector mounted with the second lens structure to the optical fiber assembly; and connecting another end of the optical fiber-side connector to the chip-side connector.

In one embodiment, the processes of connecting the end of the optical fiber-side connector equipped with the second lens structure to the optical fiber assembly includes: adjusting a position of the optical fiber assembly relative to the second lens structure; and fixing one end of the optical fiber-side connector mounted with the second lens structure to the optical fiber assembly.

In one embodiment, the chip-side connector includes a first guide pin and a first guide hole, the optical fiber-side connector includes a second guide pin and a second guide hole, the first guide pin is arranged corresponding to the second guide hole, and the second guide pin is arranged corresponding to the first guide hole.

An optical coupling system that is made according to any one of the above methods and includes: a substrate; an optical chip mounted on the substrate; an optical fiber assembly including an optical fiber and a fixing structure, and the optical fiber being fixed to the fixing structure; and a connection assembly including a chip-side connector and an optical fiber-side connector, and one end of the optical fiber-side connector is connected to a connection end surface of the optical fiber assembly, and another end of the optical fiber-side connector is detachably connected to the chip-side connector, the chip-side connector is fixed to the substrate, a fixed position of the chip-side connector on the substrate is determined according to the optical fiber-side connector that is connected to the optical fiber assembly.

In one embodiment, the optical coupling system further includes a first lens structure, the first lens structure is located on the substrate and is located on one side of the optical chip.

In one embodiment, the optical coupling system further includes a second lens structure, the second lens structure is located at one end of the optical fiber-side connector, and one end the optical fiber-side connector mounted with the second lens structure is connected to the optical fiber assembly.

In the above-mentioned optical coupling system and the preparation method therefor, the optical chip is arranged on the substrate to form the first intermediate member, and the optical fiber is fixed to the fixed structure and is connected to the optical fiber-side connector in the connection assembly, and at the same time, another end of the optical fiber-side connector is further connected to the chip-side connector to form a second intermediate member. Then, by adjusting the position of the second intermediate member relative to the first intermediate member, the chip-side connector is fixed to the substrate when the optical chip and the optical fiber achieve the optimal optical coupling.

Therefore, during the application of the optical coupling system, the chip-side connector and the optical fiber-side connector can be quickly assembled and disassembled according to needs. At the same time, the optical fiber-side connector is fixed on the substrate under a condition of achieving the optimal optical coupling between the optical chip and the optical fiber assembly. Therefore, when the chip-side connector and the optical fiber-side connector are connected again during the application, sufficiently high optical coupling efficiency with high repeatability can be ensured.

### BRIEF DESCRIPTION OF THE DRAWINGS

In order to more clearly explain the technical solutions in the embodiments of the present disclosure or the conventional technology, the drawings needed to be used in the description of the embodiments or the conventional technology will be briefly introduced below, obviously, the drawings in the following description are merely the embodiments of the present disclosure, person having ordinary skill in the art can also obtain other drawings based on these drawings without exerting creative efforts.

FIG. 1 is a flowchart of a preparation method for an optical coupling system provided in one embodiment;

FIGS. 2 to 9 are schematic cross-sectional structural schematic diagrams of the optical coupling system provided in one embodiment during a preparation process; and

FIG. 10 is a schematic three-dimensional structural schematic diagram of an optical coupling system provided in one embodiment.

### DETAILED DESCRIPTION OF THE EXEMPLARY EMBODIMENTS

In order to facilitate understanding of the present disclosure, the present disclosure will be described more fully below with reference to the relevant drawings. Embodiments of the present disclosure are given in the accompanying drawings. However, the present disclosure can be implemented in many different forms and is not limited to the embodiments described herein. Rather, these embodiments are provided so that this disclosure of the present disclosure will be thorough and complete.

Unless otherwise defined, all technical and scientific terms used herein have the same meaning as commonly understood by one of ordinary skill in the technical field to which the present disclosure belongs. The terminology used herein in the description of the application is for the purpose of describing specific embodiments only and is not intended to limit the present disclosure.

It will be understood that when an element or layer is referred to as being “on,” “adjacent,” “connected to” or “coupled to” another element or layer, it can be directly on, adjacent to, connected to, or coupled to other elements or layers, or intervening elements or layers may be present. In contrast, when an element is referred to as being “directly on,” “directly adjacent,” “directly connected to” or “directly coupled to” another element or layer, there are no intervening elements or layers present. layer. It will be understood that although the terms first, second, third, etc. may be used to describe various elements, components, regions, layers, doping types and/or sections, these elements, components, regions, layers, doping types and/or sections should not be limited by these terms. These terms are only used to distinguish one element, component, region, layer, doping type or section from another element, component, region, layer, doping type or section. Thus, a first element, component, region, layer, doping type or section discussed below could be termed a second element, component, region, layer or section without departing from the teachings of the application.

Spatial relational terms such as “under”, “under”, “under”, “under”, “on”, “above”, etc., in This may be used to describe the relationship of one element or feature to other elements or features shown in the figures. It will be understood that the spatially relative terms encompass different orientations of the device in use and operation in addition to the orientation depicted in the figures. For example, if the device in the figures is turned over, elements or features described as “below” or “under” or “beneath” other elements or features would then be oriented “above” the other elements or features. Thus, the exemplary terms “below” and “under” may include both upper and lower orientations. Additionally, the device may be otherwise oriented (e.g., rotated 90 degrees or at other orientations) and the spatial descriptors used herein interpreted accordingly.

As used herein, the singular forms “a,” “an,” and “the” may include the plural forms as well, unless the context clearly dictates otherwise. It will also be understood that the terms “comprising” or “having” and the like specify the presence of stated features, integers, steps, operations, components, parts or combinations thereof, but do not exclude the presence or addition of one or more possibility of other features, integers, steps, operations, components, parts or combinations thereof. Also, in this specification, the term “and/or” includes any and all combinations of the associated listed items.

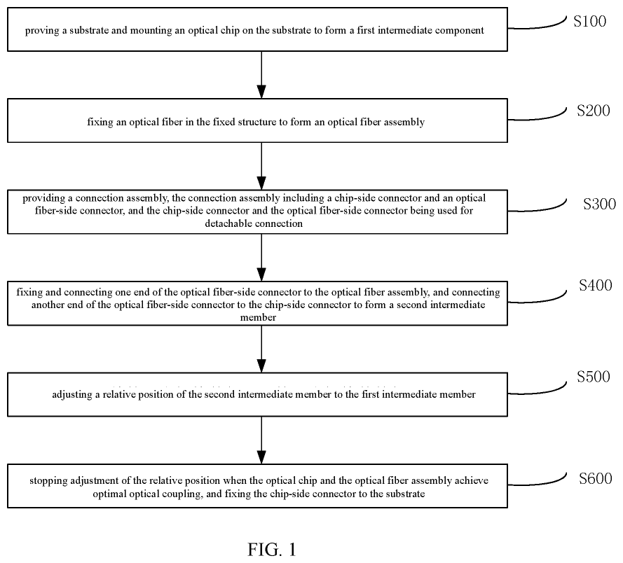

In one embodiment, reference is made to FIG. 1, which provides a preparation method for an optical coupling system for coupling and connecting an optical chip to an optical fiber.

As an example, the optical chip can be a laser, PLC, silicon light or other optical chips. Specifically, the optical chip can be an optical active device for edge lasing of a laser, or an optical passive device such as an optical waveguide with band edge coupling and reception.

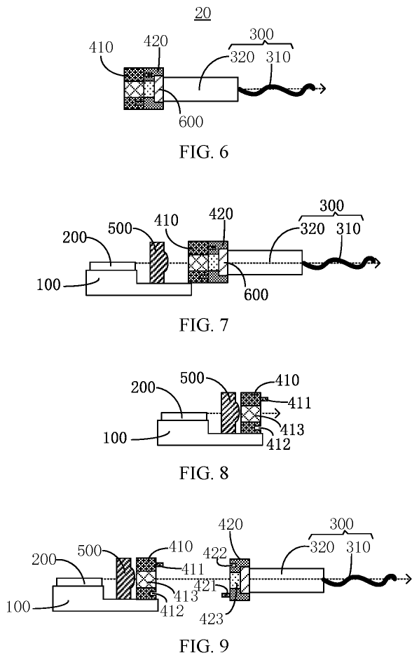

The preparation method for the optical coupling system includes the following processes:
Step S100, providing a substrate 100, and mounting an optical chip 200 on the substrate 100 to form a first intermediate component 10, which can be referred to in FIG. 3;
step S200, fixing an optical fiber 310 in the fixed structure 320 to form an optical fiber assembly 300;
step S300, providing a connection assembly 400, the connection assembly 400 including a chip-side connector 410 and an optical fiber-side connector 420, and the chip-side connector 410 and the optical fiber-side connector 420 being used for detachable connection, which can be referred to in FIG. 4;
step S400, fixing and connecting one end of the optical fiber-side connector 420 to the optical fiber assembly 300, and connecting another end of the optical fiber-side connector to the chip-side connector 410 to form a second intermediate member 20, which can be referred to in FIG. 6;
step S500, adjusting a position of the second intermediate member 20 relative to the first intermediate member 10, referring to FIG. 7; and
step S600, stopping the adjustment of the relative position when the optical chip 200 and the optical fiber assembly 300 achieve optimal optical coupling, and fixing the chip-side connector 410 to the substrate 100, referring to FIG. 8.

In step S100, the substrate 100 is a carrier substrate for the optical chip 200, and can be made of a heat sink material or other substrate materials.

Specifically, the optical chip 200 can be mounted on the substrate 100. At the same time, in addition to the optical chip, other chips and/or other circuit structures can also be provided on the substrate 100.

In step S200, the optical fiber 310 can be fixed in a fixing structure 320 with a V-groove, such that the position of the optical fiber 310 is limited and fixed through the V-groove.

At the same time, after the optical fiber 310 is fixed to the fixed structure 320 to form the optical fiber assembly 300, an end surface of the optical fiber assembly 300 can be ground and polished to form a connection end surface for easy connection, and through the connection end surface, the optical fiber 310 can be connected to one end of the optical fiber-side connector 420.

In step S300, the chip-side connector 410 and the optical fiber-side connector 420 of the connection assembly 400 can be provided with positioning structures that cooperate with each other, such that the two can be detachably connected.

As an example, the chip-side connector 410 and the optical fiber-side connector 420 can be respectively provided with a guide pin and a guide hole that cooperate with each other, such that detachable connection is performed through cooperation of the guide pin and the guide hole.

In step S400, the chip-side connector 410 and the optical fiber assembly 300 are respectively located on both sides of the optical fiber-side connector 420. Specifically, the chip-side connector 410 and the optical fiber assembly 300 can be located on opposite sides of the optical fiber-side connector 420, respectively.

At this time, the second intermediate member 20 simultaneously includes the chip-side connector 410 and the optical fiber-side connector 420 that are in a connection state, and the optical fiber assembly 300.

In step S500, a direction from the optical chip toward the optical fiber can be set as a z-axis direction, two directions perpendicular to the z-axis are respectively an x-axis direction and a y-axis direction, and the y-axis direction is perpendicular to an upper surface of the substrate.

At this time, the first intermediate member 10 can be fixed, and at the same time, a position of the second intermediate member 20 can be adjusted in x, y, and z directions through a high-precision placement equipment, thereby adjusting a distance and a spatial angle between the second intermediate member 20 and the first intermediate member 10.

Naturally, in some embodiments, the second intermediate member 20 can also be fixed, and at the same time, the position of the first intermediate member 10 is adjusted in the x, y, and z directions through the high-precision placement equipment, thereby adjusting a distance and a spatial angle between the second intermediate member 20 and the first intermediate member 10. This application is not limited thereto.

In step S500, during the adjustment the position of the second intermediate member 20 relative to the first intermediate member 10, an optical power emitted by the optical chip 200 to the optical fiber 310 can also be monitored simultaneously.

At this time, in step S600, the optimal optical coupling between the optical chip and the optical fiber is achieved when the optical power emitted from the optical chip 200 to the optical fiber is maximum. When the optical power is maximum, the chip-side connector 410 can be fixed to the 410 substrate 100 through gluing, laser welding, or eutectic soldering, such that the chip-side connector 410 is fixedly connected to the optical fiber assembly 300 to form the optical coupling system. Therefore, during the preparation process of the optical coupling system, the optical fiber-side connector 420 connected to the optical fiber assembly 300 serves as both a connector and a coupling alignment tool.

During the application of the optical coupling system, the chip-side connector 410 and the optical fiber-side connector 420 can be quickly assembled and disassembled according to requirements. At the same time, the optical fiber-side connector 420 is fixed on the substrate 100 under a condition that the optical chip 200 and the optical fiber assembly 300 achieve the optimal optical coupling. Therefore, when the chip-side connector 410 and the optical fiber-side connector 420 are connected again during application, sufficiently high optical coupling efficiency with high repeatability can also be ensured.

Moreover, one first intermediate member 10 can be adapted to multiple second intermediate members 20 produced in the same process. At the same time, one second intermediate component 20 can also be adapted to multiple first intermediate components 10 produced in the same process. Therefore, this embodiment can effectively improve the yield.

It can be understood that the preparation method for the optical coupling system of the present embodiment can be used for coupling and connection between the optical chip and the optical fiber in a single optical path, and can also support the coupling and connection between the optical chip and the optical fiber in a multi-optical path array structure.

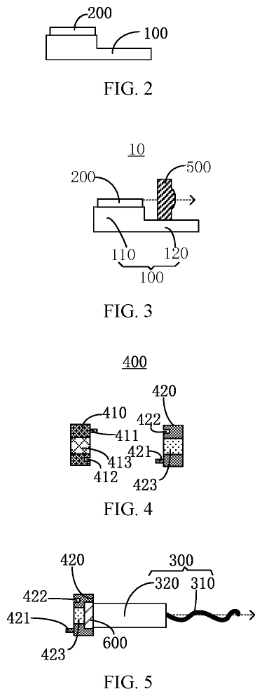

In one embodiment, step S200 includes the following processes:
step S210, providing a substrate;
step S220, mounting the optical chip 200 on the substrate 100, referring to FIG. 2; and
step S230, mounting the first lens structure 500 on the substrate 100, the first lens structure 500 being located on one side of the optical chip 200, referring to FIG. 3.

In step S220, the optical chip 200 can be mounted on the substrate 100 first.

In step S230, the first lens structure 500 can be fixed on the substrate 100 by gluing or laser welding. The first lens structure 500 can specifically be a micro-optical lens.

The first lens structure 500 is located on one side of the optical chip 200, such that small mode field beam emitted by the optical chip 200 can be collimated and expanded.

As an example, reference is made to FIG. 3, the substrate 100 can include a first mounting part 110 and a second mounting part 120 that are connected to each other. A thickness of the first mounting part 110 can be greater than a thickness of the second mounting part 120, so as to provide a step between the first mounting part 110 and the second mounting part 120.

The optical chip 200 with the smaller thickness can be mounted on the first mounting part 110 with the larger thickness, and a direction to which a light is emitted can be controlled to a direction along the direction from the first mounting part 110 to the second mounting part 120. The first lens structure 500 with the larger thickness can be mounted on the second mounting part 120 with the smaller thickness. At this time, since the first mounting part 110 is thicker than the second mounting part 120, it is beneficial for the optical chip 200 on the first mounting part 110 to emit light toward the center of the first lens structure 500, which is further beneficial for the first lens structure 500 to effectively collimate and expand the small mode field beam emitted by the optical chip 200.

Naturally, a shape of the substrate 100 is not limited thereto, and can be configured according to actual conditions.

In this embodiment, the small mode field beam emitted by the optical chip 200 can be collimated and expanded through the first lens structure 500, such that the small mode field is converted into a large mode field, thereby effectively reducing a precision for aligning and coupling the optical chip 200 to the optical fiber component 300.

Naturally, in other embodiments, the small mode field beam emitted by the optical chip 200 can be collimated and expanded in other ways, and the present disclosure is not limited thereto.

In one embodiment, step S230 includes:
Step S231, adjusting a distance of the first lens structure 500 relative to the optical chip 200; and
step S232, mounting the first lens structure 500 on the substrate 100.

In step S231, specifically, as an example, when a direction from the optical chip toward the optical fiber is set as the z-axis direction, two directions perpendicular to the z-axis being respectively the x-axis direction and the y-axis direction and the y-axis direction being perpendicular to the upper surface of the substrate, positions of the first lens structure 500 in the z-axis direction and the x-axis direction can be adjusted through relevant instruments and equipment, such that the light beam emitted by the optical chip 200 can form a light beam with higher collimation after passing through the first lens structure 500, thus facilitating effective optical coupling with the optical fiber.

It can be understood that the position of the first lens structure 500 in the y-axis direction can be reasonably controlled through process treating.

In step S232, the position-adjusted first lens structure 500 is mounted on the substrate 100.

In one embodiment, step S400 includes the following processes:
Step S410, mounting the second lens structure 600 on one end of the optical fiber-side connector 420, referring to FIG. 5;
step S420, connecting the end of the optical fiber-side connector 420 mounted with the second lens structure 600 to the optical fiber assembly 300, referring to FIG. 5; and
step S430: connecting another end of the optical fiber-side connector 420 to the chip-side connector 410, referring to FIG. 6.

In step S410, the second lens structure 600 can be integrated and mounted on the optical fiber-side connector 420 through precision placement. The second lens structure 600 can be a micro-optical lens.

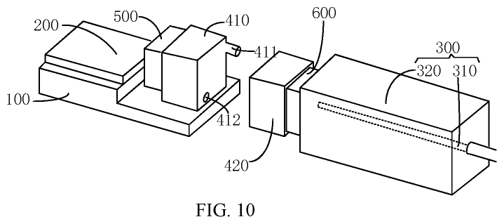

Specifically, the second lens structure 600 can be mounted on an outer end surface of the optical fiber-side connector 420 (see FIG. 10). At this time, in step S420, the end of the optical fiber-side connector 420 mounted with the second lens structure 600 can be connected to a connection end surface of the optical fiber assembly 300 through the second lens structure 600.

Naturally, the second lens structure 600 can also be mounted inside the optical fiber-side connector 420 (see FIG. 5). At this time, in step S420, the second lens structure 600 can also be connected to the connection end surface of the optical fiber assembly 300. Alternatively, the optical fiber-side connector 420 can also be connected to the optical fiber assembly 300 through the outer end surface of the end on which the second lens structure 600 is mounted (not shown). This application is not limited thereto.

In step S430, the optical fiber-side connector 420 and the chip-side connector 410 can be connected through their positioning structures being matched to each other.

In this embodiment, the small mode field beam emitted by the optical fiber assembly 300 can be collimated and expanded through the second lens structure 600, such that the small mode field is converted into a large mode field, thereby effectively reducing a precision for aligning and coupling the optical chip 200 to the optical fiber component 300.

Specifically, in some embodiments, during the preparation process of the optical coupling system, a light beam can be emitted by the optical chip 200, and then the light beam emitted by the optical chip 200 can be collimated and expanded through the first lens structure 500 to convert the small mode field to the large mode field, and then the large mode field beam is converted into a small mode field beam through the second lens structure 600 and to be emitted to the optical fiber, thereby monitoring the optical power of the optical fiber.

In one embodiment, step S420 includes:
Step S421, adjusting the position of the optical fiber component relative to the second lens structure; and
step S422: fixing the end of the optical fiber-side connector mounted with the second lens structure to the optical fiber assembly.

In step S421, specifically, as an example, when a direction from the optical chip toward the optical fiber is set as the z-axis direction, two directions perpendicular to the z-axis being respectively the x-axis direction and the y-axis direction and the y-axis direction being perpendicular to the upper surface of the substrate, positions of the optical fiber assembly 300 in the x-axis direction and the y-axis direction can be adjusted through relevant instruments and equipment, such that the light beam emitted by the optical fiber can form a light beam with higher collimation after passing through the second lens structure, thus facilitating effective optical coupling with the optical chip.

It can be understood that the position of the optical fiber assembly in the z-axis direction can be reasonably controlled through process treating. For example, a spacer with an appropriate thickness can be added between the optical fiber assembly and the second lens structure.

In step S422, specifically, the end of the optical fiber-side connector mounted with the second lens structure can be fixed to the connection end surface of the optical fiber assembly by gluing or laser welding.

In one embodiment, reference is made to FIG. 4, and the chip-side connector 410 includes a first guide pin 411 and a first guide hole 412. The optical fiber-side connector 420 includes a second guide pin 421 and a second guide hole 422.

The first guide pins 411 and the second guide holes 422 are provided correspondingly, such that they can cooperate with each other to connect the chip-side connector 410 with the optical fiber-side connector 420. At the same time, the second guide pins 421 and the first guide holes 412 are provided correspondingly, such that they can cooperate with each other to connect the chip-side connector 410 with the optical fiber-side connector 420.

In this embodiment, both the chip-side connector 410 and the optical fiber-side connector 420 have guide pins and guide holes, thereby making the connection between the chip-side connector 410 and the optical fiber-side connector 420 more stable.

Specifically, the chip-side connector 410 can further include a first light-transmitting portion 413. The first light-transmitting portion 413 is located in the center of the fiber-side connector 420, such that the light from the optical chip 200 can pass through the first light-transmitting portion 413 when the chip-side connector 410 is fixed to the substrate 100.

Similarly, the optical fiber-side connector 420 can further include a second light-transmitting portion 423. The second light-transmitting portion 423 is located in the center of the optical fiber-side connector 420, such that the second light-transmitting portion 423 faces the optical fiber assembly 300 when the optical fiber-side connector 420 is connected to the optical fiber assembly 300, thereby allowing light to pass through.

It can be understood that specific forms of the chip-side connector 410 and the chip-side connector 410 are not limited thereto, for example, the chip-side connector 410 can only be provided with guide pins, and the fiber-side connector 420 can only be provided with guide pins matching the guide pins.

In one embodiment, after step S600, the preparation method further includes:
Step S700, disassembling the chip-side connector 410 and the optical fiber-side connector 420, referring to FIG. 9.

At this time, the optical fiber-side connector 420 and the optical fiber assembly 300 connected to the optical fiber-side connector 420 can also be used to complete the fixation of another chip-side connector on other substrates with optical chips.

At the same time, after the chip-side connector 410 and the optical fiber-side connector 420 are disassembled, one side of the optical chip 200 can be further processed to achieve optoelectronic co-sealing. The optoelectronic co-sealing often requires a reflow soldering process; at this time, the chip-side connector 410 and the optical fiber-side connector 420 are disassembled, thereby preventing the optical fiber 310 from being affected by high-temperature reflow soldering process, thereby maintaining good performance.

In some embodiments, in order to better reduce the impact of the high-temperature reflow soldering process, when performing step S231 and mounting the first lens structure 500 on the substrate 100, non-adhesive methods such as laser welding or eutectic soldering can be used to fix the first lens structure 500 on the substrate 100. At the same time, in step S600, the chip-side connector 410 can be fixed to the substrate 100 through laser welding, eutectic soldering, or other methods.

It should be understood that although various steps in the flowchart of FIG. 1 are shown in sequence as indicated by arrows, these steps are not necessarily executed in the order indicated by arrows. Unless explicitly stated in this article, there is no strict restriction on the order that these steps are to be executed, and these steps can also be executed in other orders. Moreover, at least some of the steps in FIG. 1 can include multiple steps or stages, these steps or stages are not necessarily executed at the same time, but can be executed at different times, an execution order of these steps or stages does not necessarily need to be performed sequentially, but can be performed in turn or alternately with other steps or at least part of steps or stages in other steps.

In one embodiment, an optical coupling system is also provided, which is manufactured according to any one of the above methods. Reference is made to FIG. 9 or FIG. 10, the optical coupling system includes a substrate 100, an optical chip 200, an optical fiber component 300 and a connection assembly 400. The optical chip 200 is mounted on the substrate 100. The optical fiber assembly 300 includes an optical fiber 310 and a fixing structure 320, and the optical fiber 310 is fixed to the fixing structure 320.

The connection assembly 400 includes a chip-side connector 410 and an optical fiber-side connector 420, and one end of the optical fiber-side connector 420 is connected to the optical fiber assembly 300, and another end of the optical fiber-side connector 420 is detachably connected to the chip-side connector 410, the chip-side connector 410 is fixed to the substrate 100, a fixed position of the chip-side connector 410 on the substrate is determined according to the optical fiber-side connector 420 that is connected to the optical fiber-side assembly 300.

In one embodiment, the optical coupling system further includes a first lens structure 500 located on the substrate 100 and on one side of the optical chip 200.

In one embodiment, the optical coupling system further includes a second lens structure 600, the second lens structure 600 is located at one end of the optical fiber side connector 420, and one end of the optical fiber-side connector 420 mounted with the second lens structure 600 is connected to the optical fiber assembly 300.

For specific limitations on the optical coupling system, reference can be made to the above limitations on the preparation method for the optical coupling system, which will not be described again here.

In the description of this specification, reference to the description of the terms “one embodiment,” “other embodiments,” etc., means that a specific feature, structure, material, or characteristic described in connection with the embodiment or example is included in at least one embodiment or example of the present disclosure. In this application, schematic descriptions of the above terms do not necessarily refer to the same embodiment or example.

The technical features of the above embodiments can be combined in any way, to simplify the description, not all possible combinations of the technical features of the above embodiments are described. However, as long as there is no contradiction in the combination of these technical features, all possible combinations should be considered to be within the scope of this specification.

The above-described embodiments only express several implementation modes of the present disclosure, and their descriptions are relatively specific and detailed, but should not be construed as limiting the scope of the patent application. It should be noted that, for those having ordinary skill in the art, several modifications and improvements can be made without departing from the concept of the present disclosure, and these all fall within the protection scope of the present disclosure. Therefore, the scope of this patent application should be determined by the appended claims.

What is claimed is:

1. A preparation method for an optical coupling system for coupling and connecting an optical chip to an optical fiber, wherein the preparation method comprises the following processes:
providing a substrate, and mounting an optical chip on the substrate to form a first intermediate member;
fixing an optical fiber in a fixing structure to form an optical fiber assembly;
providing a connection assembly, the connection assembly including a chip-side connector and an optical fiber-side connector, and the chip-side connector and the optical fiber-side connector being used for detachable connection;
fixedly connecting one end and another end of the optical fiber-side connector to the optical fiber assembly and the chip-side connector, respectively, to form a second intermediate member;
adjusting a relative position of the second intermediate member to the first intermediate member; and
when the optical chip and the optical fiber achieve optimal optical coupling, stopping adjustment of the relative position and fixing the chip-side connector to the substrate.

2. The preparation method for the optical coupling system according to claim 1, wherein, after stopping adjustment of the relative position when the optical chip and the optical fiber achieve the optimal optical coupling and fixing the chip-side connector to the substrate, the preparation method further comprises:
disassembling the chip-side connector from the optical fiber-side connector.

3. The preparation method for the optical coupling system according to claim 1, wherein the processes of providing the substrate and mounting the optical chip on the substrate to form the first intermediate member further includes:
providing a substrate;
mounting the optical chip on the substrate; and
mounting a first lens structure on the substrate, and the first lens structure being located on one side of the optical chip.

4. The preparation method for the optical coupling system according to claim 1, wherein the processes of mounting a first lens structure on the substrate further includes:
adjusting a position of the first lens structure relative to the optical chip; and
mounting the first lens structure on the substrate.

5. The preparation method for the optical coupling system according to claim 4, wherein the processes of mounting the first lens structure on the substrate includes:
fixing the first lens structure on the substrate by laser welding or eutectic soldering;
wherein the processes of stopping adjustment of the relative position when the optical chip and the optical fiber achieve optimal optical coupling, and fixing the chip-side connector to the substrate includes:
fixing the chip-side connector on the substrate by laser welding or eutectic soldering.

6. The preparation method for the optical coupling system according to claim 1, wherein the processes of fixedly connecting one end and another end of the optical fiber-side connector to the optical fiber assembly and the chip-side connector, respectively, to form a second intermediate member includes:
mounting a second lens structure on one end of the optical fiber-side connector;
connecting one end of the optical fiber-side connector mounted with the second lens structure to the optical fiber assembly; and
connecting another end of the optical fiber-side connector to the chip-side connector.

7. The preparation method for the optical coupling system according to claim 6, wherein connecting one end of the optical fiber-side connector mounted with the second lens structure to the optical fiber assembly includes:
adjusting a position of the optical fiber assembly relative to the second lens structure; and
fixing one end of the optical fiber-side connector mounted with the second lens structure to the optical fiber assembly.

8. The preparation method for the optical coupling system according to claim 1, wherein,
the chip-side connector includes a first guide pin and a first guide hole;
the optical fiber-side connector includes a second guide pin and a second guide hole; and
the first guide pin is arranged corresponding to the second guide hole, and the second guide pin is arranged corresponding to the first guide hole.

9. An optical coupling system, wherein the optical coupling system is made according to the preparation method of claim 1 and comprises:
a substrate;
an optical chip mounted on the substrate;
an optical fiber assembly including an optical fiber and a fixing structure, and the optical fiber being fixed to the fixing structure; and
a connection assembly including a chip-side connector and an optical fiber-side connector, and one end of the optical fiber-side connector being connected to a connection end surface of the optical fiber assembly, and another end of the optical fiber-side connector being detachably connected to the chip-side connector, the chip-side connector being fixed to the substrate, and a fixed position of the chip-side connector on the substrate being determined according to the optical fiber-side connector that is connected to the optical fiber assembly.

10. The optical coupling system according to claim 9, wherein the optical coupling system further comprises a first lens structure, the first lens structure is located on the substrate and is located on one side of the optical chip.

11. The optical coupling system according to claim 9, wherein the optical coupling system further comprises a second lens structure, the second lens structure is located at one end of the optical fiber-side connector, and one end the optical fiber-side connector mounted with the second lens structure is connected to the optical fiber assembly.
